(19) United States
(12) Patent Application Publication
(10) Pub. No.: US 2024/0024962 A1
(43) Pub. Date: Jan. 25, 2024

(54) Expansion Clamping Sleeve and Hydraulic Expansion Clamping Chuck

(71) Applicant: KENNAMETAL INC., Latrobe, PA (US)

(72) Inventor: Josef Konrad Herud, Fuerth (DE)

(21) Appl. No.: 18/220,568

(22) Filed: Jul. 11, 2023

(30) Foreign Application Priority Data
Jul. 22, 2022 (DE) 102022207526.9

(51) Int. Cl. B23B 31/30

(52) U.S. Cl. CPC B23B 31/305; B23B 31/302

(57) ABSTRACT

The invention relates to an expansion clamping sleeve (6) comprising a sleeve body (30) having a tool receptacle (24) for a chipping tool, wherein the sleeve body (30) is expanded in a longitudinal direction (10) as well as in a radial direction (20) transverse to the longitudinal direction (10), wherein the sleeve body (30) comprises a pressure membrane (44) delimiting a hydraulic chamber (40) in the sleeve body (30), and wherein the sleeve body (30) comprises a receptacle (46) for a mechanical actuator (48) for activating the pressure membrane (44). In addition, the invention relates to a hydraulic expansion clamping chuck (2) having such an expansion clamping sleeve (6).

### RELATED APPLICATION DATA

The present application claims priority under 35 U.S.C. § 119 to German Patent Application No. 102022207526.9, filed on Jul. 22, 2022, the disclosure of which is incorporated by reference herein in its entirety.

### FIELD

The invention relates to an expansion clamping sleeve. Furthermore, the invention relates to a hydraulic expansion clamping chuck.

### BACKGROUND

A hydraulic expansion clamping chuck, also known as a hydro-expansion clamping chuck, is used in order to receive a chipping tool as well as to connect the chipping tool to a spindle or drive shaft of a machine tool. For this purpose, a corresponding hydraulic expansion chuck comprises a tool receptacle into which a shaft of the chipping tool can be inserted and in which the shaft of the chipping tool can be fixed. The fixation is carried out by a hydraulically controlled reversible deformation of the tool receptacle. Based on the foregoing, the problem addressed by the invention is to specify an advantageous device for receiving a chipping tool.

### SUMMARY

According to the present invention, this problem is solved by an expansion clamping sleeve comprising a sleeve body having a tool receptacle for a chipping tool, wherein the sleeve body is expanded in a longitudinal direction as well as in a radial direction transverse to the longitudinal direction, wherein the sleeve body comprises a pressure membrane delimiting a hydraulic chamber in the sleeve body, and wherein the sleeve body comprises a receptacle for a mechanical actuator for activating the pressure membrane.

Furthermore, according to the present invention, this problem is solved by a hydraulic expansion clamping chuck comprising such an expansion clamping sleeve.

The following advantages and preferred designs given with regard to the expansion clamping sleeve can be transferred to the hydraulic expansion clamping chuck and vice versa.

A hydraulic expansion clamping chuck according to the invention now has an expansion clamping chuck according to the invention, and, vice versa, the expansion clamping chuck according to the invention is suitably designed for a hydraulic expansion clamping chuck according to the invention or for forming such a hydraulic expansion clamping chuck.

In this case, the expansion clamping sleeve comprises a sleeve body with a tool receptacle for a chipping tool, in particular a rotatable chipping tool with a shaft, for example a milling tool, a drill, or a reamer. Thus, the expansion clamping sleeve is suitably designed so as to receive a corresponding chipping tool such that the shaft of the chipping tool can be inserted into the tool receptacle and the shaft can also be fixed in the tool receptacle, depending on the operating state.

The sleeve body extends in a longitudinal direction on the one hand and in a radial direction transverse to the longitudinal direction on the other hand, wherein the sleeve body is elongated in the longitudinal direction, for example, depending on the design variant. The tool receptacle is conveniently designed around a central longitudinal axis of the sleeve body extending in the longitudinal direction and typically has cylindrical geometry in a home position.

Furthermore, the sleeve body comprises a pressure membrane that delimits a hydraulic chamber in the sleeve body. The hydraulic chamber serves here expediently for the fixation of a shaft of a chipping tool in the tool receptacle by a hydraulically controlled or hydraulically initiated reversible deformation of the tool receptacle.

In addition, the sleeve body comprises a receptacle for a mechanical actuator for activating the pressure membrane, which is typically designed so as to be flexible. The expansion clamping sleeve is thus designed in particular so as to convert a mechanical force exerted by the actuator via the pressure membrane into a hydraulic pressure in the hydraulic chamber and to provide the reversible deformation of the tool receptacle via the hydraulic pressure in the hydraulic chamber. The sleeve body is suitably designed such that the volume of the tool holder is reduced by the reversible deformation of the tool holder.

Design variants are preferred in which the sleeve body is designed as a monolithic sleeve body and in which this monolithic sleeve body forms the pressure membrane. The sleeve body is thus preferably made in one piece and integrally designed, and the pressure membrane is designed as an integral component. Design variants in which the sleeve body consists of a metal or metal alloy are particularly expedient.

Such a monolithic sleeve body made of a metal or metal alloy is further preferably produced by means of a 3D printing process, for example by means of a so-called direct metal laser sintering (DMLS), by means of a so-called direct additive laser construction (CLAD), or by means of a so-called filament-metal printing (FFF method/FDM method).

It is expedient when the sleeve body forms the hydraulic chamber as well as a clearance and when the pressure membrane separates the hydraulic chamber and the clearance from one another. Such a clearance is in particular an internal clearance, which is typically connected to the environment surrounding the sleeve body by the receptacle for the mechanical actuator. Preferably, a connection between the clearance and the hydraulic chamber is not designed.

Regardless, in most applications, the hydraulic chamber preferably extends over at least 40% of the expansion of the sleeve body in the longitudinal direction, further preferably over at least 50%. In addition, the hydraulic chamber typically has a geometry that well approximates a hollow cylinder. Expediently, the hydraulic chamber and tool receptacle are also arranged concentrically about the central longitudinal axis of the sleeve body.

The clearance, in turn, typically extends in the longitudinal direction over a length that is greater than or equal to 20% of the expansion of the sleeve body in the longitudinal direction, further preferably greater than or equal to 30%. The geometry of the clearance well approximates a hollow cylinder segment, which is further preferably arranged concentrically to the aforementioned central longitudinal axis of the sleeve body. The clearance typically extends over an angular range of less than or equal to 180° about the central longitudinal axis, further preferably less than or equal to 120°.

As already indicated, a mechanical actuator is provided for activating the pressure membrane, which is typically part of the expansion clamping sleeve. The receptacle for the actuator typically comprises a type of abutment on which the actuator can support itself for a transfer of force to the pressure membrane. Preferably, the actuator is designed as a screw, for example as a grub screw, and the receptacle is suitably designed as a tapped hole, which extends in particular in the radial direction. In this case, the thread then serves as an abutment for the actuator, i.e., the screw.

In particular, when the actuator is formed by a screw, it is further advantageous when the pressure membrane comprises a reinforced wall region as an abutment or as a tool access for the actuator. In addition, a design in which the reinforced wall region is positioned approximately centrally when viewed in the longitudinal direction with respect to the expansion of the pressure membrane is expedient in this case. In addition, it is expedient when the expansion of the reinforced wall region is adapted to the dimensions of the actuator, i.e., for example to the diameter of a screw functioning as the actuator.

Furthermore, designs are expedient in which the sleeve body forms an inner wall and an outer wall, wherein the inner wall forms the tool receptacle, wherein the hydraulic chamber is formed between the inner wall and the outer wall, and wherein the outer wall comprises the clearance and thereby forms the pressure membrane. The inner wall then separates the tool receptacle from the hydraulic chamber, and the outer wall separates the hydraulic chamber from the surrounding environment. A design of the inner wall in which three portions are formed when viewed in the longitudinal direction is furthermore typical here. A central portion expediently has a greater wall thickness than the two outer portions that adjoin the central portion.

To fill the hydraulic chamber, the sleeve body further expediently comprises at least one filling opening, namely a first filling opening. The filling opening is preferably designed as a tapped hole or comprises at least one tapped hole. Further preferably, a connecting passage adjoins the filling opening and connects the filling opening to the hydraulic chamber. In this case, a receptacle for a sealing element is typically designed in the filling opening, in the connection passage, or in a transition between the filling opening and the connection passage, for example a ball seal.

Depending on the application, the sleeve body further comprises a second filling opening for filling the hydraulic chamber. The second filling opening is preferably designed according to the same manner as the first filling opening. The two filling openings are then suitably arranged spatially separate from one another, for example on opposite sides of the central longitudinal axis of the sleeve body and/or, when viewed in the longitudinal direction, at opposite ends of the sleeve body.

In particular, when the sleeve body comprises two filling openings, a hydraulic interface for connecting the hydraulic chamber to an external hydraulic system is preferably omitted. Thus, in particular, a hydraulic interface for connection to a carrier unit for the expansion clamping sleeve is omitted, i.e., typically a carrier unit of the hydraulic expansion clamping chuck according to the invention.

Alternatively, the sleeve body has a corresponding hydraulic interface for connecting the hydraulic chamber to an external hydraulics. The hydraulic interface is then formed, for example, by one or more passages or holes.

Furthermore, designs of the expansion clamping sleeve are advantageous in which the sleeve body forms a flange with a number of holes for screwing the sleeve body to a carrier unit, typically a carrier unit of the hydraulic expansion clamping chuck according to the invention. The sleeve body typically extends in the longitudinal direction from a first end to a second end. One of the two ends then forms the flange. Preferably, in such cases, the hydraulic chamber usually additionally extends into the flange in the longitudinal direction.

A design is further expedient in which the sleeve body comprises a positioning aid, such as a pin or a recess, through which a positioning of the expansion clamping sleeve in a receptacle of a carrier unit, typically a carrier unit of the hydraulic expansion clamping chuck according to the present invention, is made easier, whereby it is ensured, in particular, that the expansion clamping sleeve is easily positionable in the receptacle in a predetermined rotational position.

It is also advantageous when the sleeve body is designed so as to form an anti-rotation feature, i.e., to fix the relative rotational position of the expansion clamping sleeve in relation to a carrier unit, typically a carrier unit of the hydraulic expansion clamping chuck according to the invention. For this purpose, for example, the sleeve body comprises a groove for receiving a number of groove blocks, or the sleeve body comprises one or more groove blocks.

In some applications, a number of cavities are further formed by the sleeve body, i.e., the sleeve body comprises one or more cavities, i.e., quasi-cavities in addition to the cavities for the hydraulics, for forming the clearance, and for forming the receptacle for the actuator. These additional cavities are then typically used in order to conserve material and cost. A design variant in which a type of honeycomb structure is formed in the sleeve body at least in one region is particularly expedient, wherein the honeycomb structure then forms such additional cavities. Such design variants are particularly advantageous and preferable when the sleeve body is manufactured by means of a 3D printing process.

In addition, designs in which the sleeve body comprises at least one cooling passage for passing a coolant are advantageous. If the sleeve body then comprises the inner wall and the outer wall as described above, the at least one cooling passage according to one design variant is guided through the outer wall.

As already stated above, the problem set forth is further solved according to the invention by a hydraulic expansion clamping chuck comprising the expansion clamping sleeve described above. The hydraulic expansion clamping chuck is designed either for a machine tool or is designed on a machine tool. If the hydraulic expansion clamping chuck is designed for a machine tool, it expediently comprises a machine interface, for example a hollow shaft cone interface (HSK interface, briefly HSK) or a steep cone interface (SC interface, briefly SC).

Independently of this, in the hydraulic expansion clamping chuck according to the invention, the formation of a clamping piston conventionally used with classic hydraulic expansion clamping chucks is omitted. Instead, the hydraulic expansion clamping chuck comprises the clamping sleeve with the pressure membrane and the actuator.

Furthermore, the hydraulic expansion clamping chuck expediently comprises a carrier unit having a receptacle for the expansion clamping sleeve. The receptacle is typically at least approximately cylindrical. The carrier unit is preferably designed for a reversibly releasable connection to the expansion clamping sleeve, wherein further preferably the expansion clamping sleeve can be fixed to or in the carrier unit by way of at least one screw connection. The expansion sleeve is thus designed as a replacement part. In some applications, the carrier unit and the expansion clamping sleeve are also designed for a press fit.

According to at least one design variant, the carrier unit comprises one or more tapped holes on a front side for forming one or more screw connections between the clamping sleeve and the carrier unit. This design of the carrier unit is particularly advantageous for expansion clamping sleeves having a flange.

Alternatively, the carrier unit comprises on an end face a screw thread for screwing on a locking ring and thus for fixing the expansion clamping sleeve in the receptacle of the carrier unit. The carrier unit and the associated expansion clamping sleeve are then typically designed such that the expansion clamping sleeve is countersunk in the receptacle in the course of assembly and the receptacle is quasi-closed on the end side with the locking ring.

The locking ring typically has an outer diameter that is greater than the diameter of the receptacle. That is to say, the expansion of the locking ring in the radial direction is greater than the expansion of the receptacle in the radial direction. The inner diameter of the locking ring typically has an expansion in the radial direction, which corresponds approximately to the expansion of the tool receptacle of the expansion clamping sleeve.

A design is further expedient in which the carrier unit comprises a positioning aid, such as a pin or a recess, through which a positioning of the expansion clamping sleeve in the receptacle is made easier, whereby it is ensured, in particular, that the expansion clamping sleeve is easily positionable in the receptacle in a predetermined rotational position.

It is also advantageous when the carrier unit, and in particular the receptacle of the carrier unit, is designed so as to form an anti-rotation feature, i.e., to fix the relative rotational position of an inserted expansion clamping sleeve in relation to the carrier unit. For this purpose, for example, the receptacle comprises a groove for receiving a number of groove blocks, or the receptacle comprises one or more groove blocks.

It is further expedient when the carrier unit comprises an opening for the actuator. The opening is in particular designed as an access opening, i.e., as an opening that allows access from the outside to the actuator of an expansion clamping sleeve mounted in the receptacle.

It is further advantageous when the carrier unit comprises a further opening. The further opening is in particular designed as a further access opening, namely as an opening that allows access from the outside to a filling opening of an expansion clamping sleeve mounted in the receptacle.

In some applications, the carrier unit also comprises at least one filling opening for filling the hydraulic chamber of the expansion clamping sleeve. The filling opening is preferably designed as a tapped hole or comprises at least one tapped hole. Further preferably, a hydraulic passage adjoins the filling opening. In this case, a receptacle for a sealing element is typically designed in the filling opening, in the connection passage, or in a transition between the filling opening and the connection passage, for example a ball seal.

If the carrier unit comprises at least one filling opening for filling the hydraulic chamber of the expansion clamping sleeve, then a hydraulic interface is typically also formed, via which an exchange of hydraulic fluid between the carrier unit and an expansion clamping sleeve mounted in the receptacle is enabled. In this case, a seat for a seal, for example a sealing ring, is typically integrated into the hydraulic interface.

### BRIEF DESCRIPTION OF THE DRAWINGS

Exemplary designs of the invention are explained in further detail in the following on the basis of a schematic drawing. The following are shown:

FIG. 1 in a first longitudinal section, a first design of a hydraulic expansion clamping chuck,

FIG. 2 in a first cross-section, the first design of the hydraulic expansion clamping chuck,

FIG. 3 in a second longitudinal section, a second design of the hydraulic expansion clamping chuck,

FIG. 4 in a second cross-section, the second design of the hydraulic expansion clamping chuck, and

FIG. 5 in a third longitudinal section, a portion of the second design of the hydraulic expansion clamping chuck.

Parts corresponding to one another bear the same reference numerals in the figures.

### DETAILED DESCRIPTION

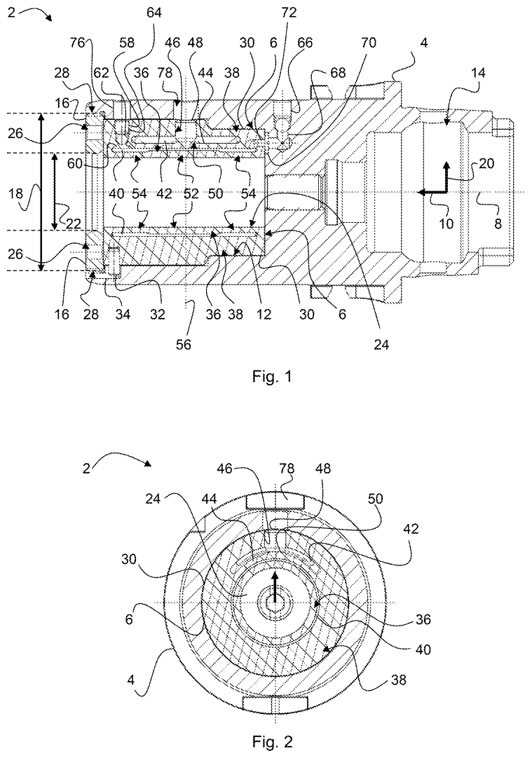

A hydraulic expansion clamping chuck 2, described hereinafter by way of example, comprises a carrier unit 4 and an expansion clamping sleeve 6 mounted in the carrier unit 4. The expansion clamping sleeve 6 is reversibly releasably connected to the carrier unit 4 and thereby can be simply replaced. FIG. 1 shows a longitudinal section through the hydraulic expansion clamping chuck 2. A central longitudinal axis 8 lies in the cutting plane.

The carrier unit 4 is expanded around this central longitudinal axis 8 and extends in a longitudinal direction 10 along the central longitudinal axis 8 from a first end to a second end. The first end, shown on the left in FIG. 1, forms a receptacle 12 for the expansion clamping sleeve 6, and the second end, shown on the right in FIG. 1, forms a machine interface 14, which, in the exemplary design, is designed as a hollow shaft cone interface (HSC interface, briefly HSC).

The receptacle 12 is formed substantially symmetrically around the central longitudinal axis 8 and has at least approximately a cylindrical shape. The expansion clamping sleeve 6 is inserted in the receptacle 12, and a locking ring 16 is screwed into an end-side opening of the receptacle 12, which locks the opening and fixes the expansion clamping sleeve 6 in the receptacle 12.

The locking ring 16 has an outer diameter 18 that is larger than the diameter of the receptacle 12. That is to say, the expansion of the locking ring 16 in a radial direction 20 transverse to the longitudinal direction 10 is greater than the expansion of the receptacle 12 in the radial direction 20. The inner diameter 22 of the locking ring 16 has an expansion in the radial direction 20, which corresponds approximately to the expansion of a tool receptacle 26 of the expansion clamping sleeve 6. In FIG. 1, a tool access 26 in the locking ring 16 is also indicated, which facilitates the screwing of the locking ring 16 into a screw thread 28 on the carrier unit 4.

The expansion clamping sleeve 6 comprises a sleeve body 30, which, according to FIG. 1, is arranged countersunk in the receptacle 12 of the carrier unit 4. For easier assembly, a positioning pin 32 is formed on the sleeve body 30, and a recess 34 is formed in the carrier unit 4. The sleeve body 30 can thus only be inserted into the receptacle 12 in a predetermined rotational position.

In the exemplary design, the sleeve body 30 is designed as a monolithic sleeve body 30 and consists of a metal or metal alloy. Preferably, the sleeve body 30 is manufactured by means of a 3D printing process, for example by means of a so-called direct metal laser sintering (DMLS), by means of a so-called direct additive laser construction (CLAD), or by means of a so-called filament-metal printing (FFF method/FDM method).

The sleeve body 30 comprises the aforementioned tool receptacle 24 for receiving a shaft (not shown) of a rotatable chipping tool, such as a milling tool, a drill, or a reamer. According to FIG. 1, the sleeve body 30 further extends in the longitudinal direction 10 on the one hand and in the radial direction 20 on the other hand, wherein the sleeve body 30 is elongated in the longitudinal direction 10, for example, depending on the design variant. The tool receptacle 24 is formed around the central longitudinal axis 8 and has a cylindrical geometry at least in a home position as shown in FIG. 1.

The sleeve body 30 forms an inner wall 36 and an outer wall 38, wherein the inner wall 36 forms the tool receptacle 24, wherein the hydraulic chamber 40 is formed between the inner wall 36 and the outer wall 38, and wherein the outer wall 38 comprises a clearance 42 and thereby forms the pressure membrane 44. The inner wall 36 separates the tool receptacle 24 from the hydraulic chamber 40, and the outer wall 38 separates the hydraulic chamber 40 from the surrounding environment.

In addition, the sleeve body 30 forms a receptacle 46 for a mechanical actuator, which, in the exemplary design, is formed by a grub screw 48. The receptacle 46 is formed by a tapped hole, which extends in the radial direction 20. The grub screw 48 serves to activate the pressure membrane 44, which is typically designed so as to be flexible.

The expansion clamping sleeve 6 is thus designed so as to convert a mechanical force exerted by the grub screw 48 via the pressure membrane 44 into a hydraulic pressure in the hydraulic chamber 40 and to provide a reversible deformation of the tool receptacle 24 via the hydraulic pressure in the hydraulic chamber 40. The sleeve body 30 is thus suitably designed such that the volume of the tool receptacle 24 is reduced by the reversible deformation of the tool receptacle 24.

According to FIG. 1, the pressure membrane 44 comprises a reinforced wall region as an abutment 50 or as a tool access for the actuator, i.e., the grub screw 48. In addition, a design in which the reinforced wall region is positioned approximately centrally when viewed in the longitudinal direction 10 with respect to the expansion of the pressure membrane 44, as shown in FIG. 1, is expedient in this case. In addition, it is expedient when the expansion of the reinforced wall region is adapted to the dimensions of the actuator, i.e., in this case to the diameter of the grub screw 48.

FIG. 1 further shows a design of the inner wall 36 in which three portions are formed when viewed in the longitudinal direction 10. A central portion 52 has a greater wall thickness than the two outer portions 54 that adjoin the central portion 52.

Furthermore, the hydraulic chamber 40 preferably extends over at least 40% of the expansion of the sleeve body 30 in the longitudinal direction 10, further preferably over at least 50%. In addition, in the exemplary design, the hydraulic chamber 40 has a geometry that well approximates a hollow cylinder.

The clearance 42, in turn, preferably extends in the longitudinal direction 10 over a length that is greater than or equal to 20% of the expansion of the sleeve body 30 in the longitudinal direction 10, further preferably greater than or equal to 30%. The geometry of the clearance 42 well approximates a hollow cylinder segment, which is arranged concentrically to the central longitudinal axis 8. The clearance 42 typically extends over an angular range of less than or equal to 180° about the central longitudinal axis 8, further preferably less than or equal to 120°. This can be seen in FIG. 2. FIG. 2 shows a cross-section transverse to the longitudinal section according to FIG. 1. The position of the cross-section is indicated by the intersecting line 56 in FIG. 1.

To fill the hydraulic chamber 40, the sleeve body 30 further comprises a filling opening 58. The filling opening 58 is designed as a tapped hole. Furthermore, a connecting passage 60 adjoins the filling opening 58 and connects the filling opening 58 to the hydraulic chamber 40. In the exemplary design, the filling opening 58 is closed by a ball seal 62 held by a grub screw 64.

A second filling opening 66 for filling the hydraulic chamber 40 comprises the carrier unit 4. The second filling opening 66 is in turn designed as a tapped hole and is closed by a ball seal 62, which is held by a grub screw 64. A hydraulic passage 68 further adjoins the second filling opening 66 and connects the filling opening 66 to a hydraulic interface 70. In the exemplary design, the hydraulic interface 70 connects the hydraulic passage 68 of the carrier unit 4 to a hydraulic interface 72 of the expansion clamping sleeve 6, which in turn is connected to the hydraulic chamber 40.

In this design variant of the hydraulic expansion clamping chuck 2, the filling with a hydraulic fluid takes place with the expansion clamping sleeve 6 mounted. The expansion clamping rate can then be optionally adjusted via each of the two filling openings 58, 66.

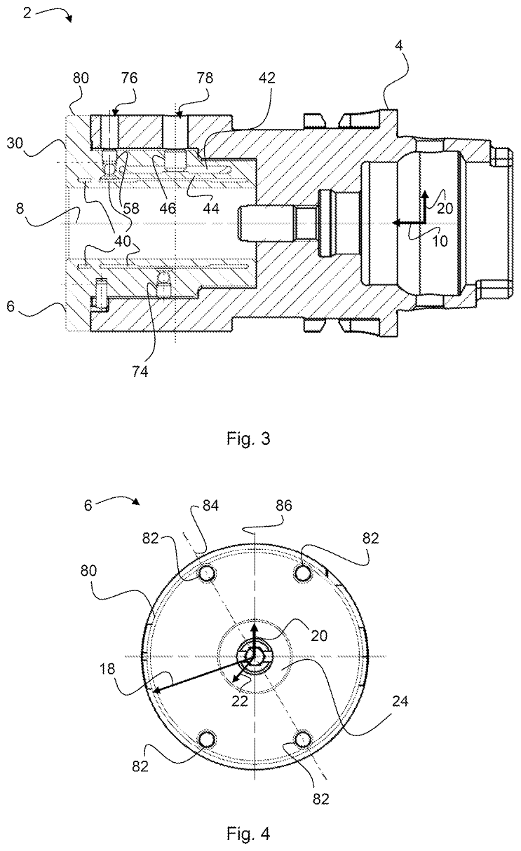

An alternative design of the hydraulic expansion clamping chuck 2 is shown in FIG. 3 to FIG. 5. Here, the carrier unit 4 does not have a filling opening 66, and no hydraulic interface 70, 72 is formed between the carrier unit 4 and the expansion clamping sleeve 6.

Instead, the expansion clamping sleeve 6 itself comprises a second filling opening 74 for filling the hydraulic chamber 40, which is designed analogously to the first filling opening 58. That is to say, the second filling opening 74 is designed as a tapped hole and is closed by a ball seal 62, which is held by a grub screw 64. In this design variant of the hydraulic expansion clamping chuck 2, the filling takes place prior to the assembly of the expansion clamping sleeve 6. However, the expansion clamping rate can also be adjusted after assembly of the expansion clamping sleeve 6, namely via the filling opening 58. An access opening 76 is designed on the carrier unit 4 for this purpose, which allows access to the filling opening 58 from the outside after the assembly of the expansion clamping sleeve 6. A further access opening 78 on the carrier unit 4 allows for an external access to the grub screw 48, i.e., the actuator for the pressure membrane 44. No access opening is provided for the filling opening 74 in the exemplary design.

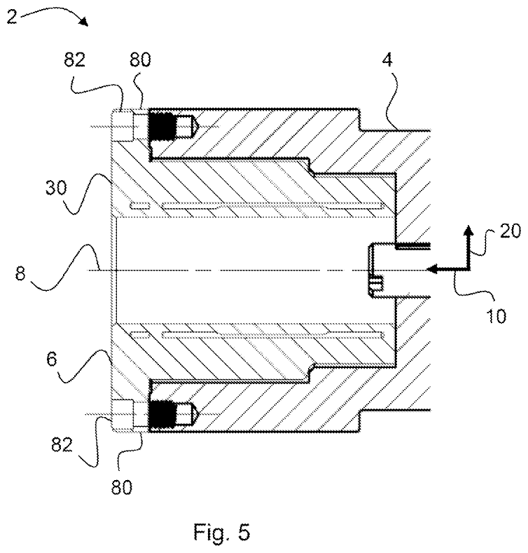

A further difference is that the expansion clamping sleeve 6 is not retained by a locking ring 16 in the case of the design variant according to FIG. 3 to FIG. 5. Instead, the expansion clamping sleeve 6 forms a flange 80 that is screwed to the carrier unit 4. In the assembled state, screws 82 then penetrate holes in the flange 80 and are screwed into tapped holes of the carrier unit 4. This is shown in FIG. 5. FIG. 5 shows a portion of a longitudinal section that traverses the axis 84 in FIG. 4. FIG. 4, in turn, shows a front view of the alternative design of the hydraulic expansion.

1. An expansion clamping sleeve comprising a sleeve body having a tool receptacle for a chipping tool, wherein the sleeve body is expanded in a longitudinal direction as well as in a radial direction transverse to the longitudinal direction, wherein the sleeve body comprises a pressure membrane delimiting a hydraulic chamber in the sleeve body, and wherein the sleeve body comprises a receptacle for a mechanical actuator for activating the pressure membrane.

2. The expansion clamping sleeve according to claim 1,
wherein the sleeve body is designed as a monolithic sleeve body, and
wherein the monolithic sleeve body forms the pressure membrane.

3. The expansion clamping sleeve according to claim 1,
wherein the sleeve body forms the hydraulic chamber as well as a clearance, and wherein the pressure membrane separates the hydraulic chamber and the clearance from one another.

4. The expansion clamping sleeve according to claim 1,
wherein the receptacle is designed as a tapped hole for an adjustment screw as the actuator.

5. The expansion clamping sleeve according to claim 3,
wherein the pressure membrane comprises a reinforced wall region as an abutment for the actuator.

6. The expansion clamping sleeve according to claim 1,
wherein the sleeve body forms an inner wall and an outer wall, wherein the inner wall forms the tool receptacle, wherein the hydraulic chamber is formed between the inner wall and the outer wall, and wherein the outer wall comprises the clearance and thereby forms the pressure membrane.

7. The expansion clamping sleeve according to claim 1,
wherein the sleeve body comprises at least one filling opening for filling the hydraulic chamber.

8. The expansion clamping sleeve according to claim 1,
wherein a hydraulic interface for connecting hydraulic chamber to an external hydraulics is omitted.

9. The expansion clamping sleeve according to claim 1,
wherein the sleeve body forms a flange having a number of holes for screwing the sleeve body to a carrier unit.

10. A hydraulic expansion clamping chuck comprising an expansion clamping sleeve according to claim 1.

11. The hydraulic expansion clamping chuck according to claim 10,
wherein it comprises a carrier unit with a receptacle for the expansion clamping sleeve, and wherein the carrier unit is designed for a reversibly releasable connection to the expansion clamping sleeve.

12. The hydraulic expansion clamping chuck according to claim 11,
wherein the carrier unit comprises on an end face a number of tapped holes for forming a screw connection between the expansion clamping sleeve and the carrier unit.

13. The hydraulic expansion clamping chuck according to claim 11,
wherein the carrier unit comprises on an end face a screw thread for screwing on a locking ring for fixing the expansion clamping sleeve in the receptacle of the carrier unit.

14. The hydraulic expansion clamping chuck according to claim 10,
wherein the carrier unit comprises an opening for the actuator.

15. The hydraulic expansion clamping chuck according to claim 10,
wherein the carrier unit comprises a filling opening for filling the hydraulic chamber of the expansion clamping sleeve.
